(19) United States
(12) Patent Application Publication
(10) Pub. No.: US 2011/0062801 A1
(43) Pub. Date: Mar. 17, 2011

(54) LINEAR VIBRATOR

(76) Inventors: Joon CHOI, Gyunggi-do (KR); Min Young So, Gyunggi-do (KR)

(21) Appl. No.: 12/630,432

(22) Filed: Dec. 3, 2009

(30) Foreign Application Priority Data
Sep. 14, 2009 (KR) 10-2009-0086615

(51) Int. Cl. H02K 33/00

(52) U.S. Cl. 310/17

(57) ABSTRACT

Disclosed herein is a linear vibrator. The linear vibrator includes a casing, a vibration unit, a bracket, a circuit board, a coil unit, a lead wire and a soldering part. The casing defines an internal space therein. The vibration unit is provided in the casing and vibrates upwards and downwards. The bracket supports the casing and the vibration unit. The circuit board is provided on the bracket. An electric circuit and a plurality of electronic devices are provided on the circuit board. The coil unit is mounted to the central portion of the circuit board in a perpendicular direction, so that power is applied from the circuit board to the coil unit. The lead wire extends from the lower end of the coil unit and is electrically connected to the circuit board. The soldering part is formed on the circuit board to connect the lead wire to the circuit board and disposed at a position other than the position corresponding to the direction in which external tension is applied to the circuit board when power is applied to the coil unit.

### CROSS REFERENCE TO RELATED APPLICATION

This application claims the benefit of Korean Patent Application No. 10-2009-0086615, filed Sep. 14, 2009, entitled “Linear Vibrator”, which is hereby incorporated by reference in its entirety into this application.

### BACKGROUND OF THE INVENTION

1. Technical Field

The present invention relates to a linear vibrator.

2. Description of the Related Art

Generally, portable electronic devices, such as mobile phones, have a means for generating vibrations which is one of the critical characteristics of the devices. To provide this, in the conventional art, a vibration motor which generates vibrations in such a way as to rotate an eccentric shaft or a shaft misaligned from the center of gravity thereof has been used.

However, when the conventional vibration motor rotates, a brush passes through a gap between segments, so that friction and sparks occur with the result that many problems are induced, for example, the lifetime of the motor is reduced.

In an effort to overcome the above-mentioned disadvantages of the vibration motor, a linear motor was proposed. The linear motor is constructed such that a vibration unit coupled to a spring vibrates in the vertical or horizontal direction using electromagnetic force generated between a magnet and a coil. Thus, compared to the vibration motor, friction and abrasion between elements are reduced, thereby increasing the lifetime of the motor. Furthermore, the linear vibrator can be manufactured in a small size. Due to these advantages, various styles of linear vibrators are being developed.

However, in the case of the conventional linear vibrator, because of a complication of the structure of the linear vibrator according to the reduction in size thereof, an event in which a structure for connecting the linear vibrator to a portable electronic device is broken may be frequently caused. In other words, the structure for connecting the linear vibrator to the electronic device is complex, so that a power connection terminal may be easily snapped by force applied thereto when connecting the linear vibrator to the to electronic device.

If the power connection terminal is broken, the linear vibrator cannot be operated, of course. This markedly reduces the reliability of the product.

Therefore, to prevent the power connection terminal from snapping even though external tension is applied thereto, a method of improving the internal structure of the linear vibrator is required.

### SUMMARY OF THE INVENTION

The present invention has been made in an effort to provide a linear vibrator which can prevent the problem of the power connection terminal between the linear vibrator and an electronic device snapping.

In a linear vibrator according to an embodiment of the present invention, a casing defines an internal space therein. A vibration unit is provided in the casing. The vibration unit vibrates upwards and downwards. A bracket supports the casing and the vibration unit. A circuit board is provided on the bracket. The circuit board is made of elastic material. An electric circuit and a plurality of electronic devices are provided on the circuit board. A coil unit is mounted to a central portion of the circuit board in a perpendicular direction, so that power is applied from the circuit board to the coil unit. A lead wire extends from a lower end of the coil unit. The lead wire is electrically connected to the circuit board. A soldering part is formed on the circuit board to connect the lead wire to the circuit board. The soldering part is disposed at a position other than a position corresponding to a direction in which a tension is applied to the circuit board when power is applied to the coil unit.

Furthermore, an orientation of the soldering part based on a center of the circuit board may be angled by 180° to the direction in which the external tension is applied to the circuit board.

In addition, an orientation of the soldering part based on a center of the circuit board may be angled by from 90° to 180° to the direction in which the external tension is applied to the circuit board.

In the present invention, the orientation of a soldering part on which a lead wire of a coil unit is coupled to a circuit board by soldering is not aligned with the direction in which external tension is applied to the circuit board. Therefore, when the circuit board of the linear vibrator is assembled with an electronic device, even though external tension is applied to the circuit board, the snapping of the wire on the soldering part can be prevented.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view of a linear vibrator, according to the present invention;

FIG. 2 is an exploded perspective view of the linear vibrator according to the present invention;

FIG. 3 is a partial enlarged view illustrating a first embodiment of the linear vibrator according to the present invention; and

FIG. 4 is a partial enlarged view illustrating a second embodiment of the linear vibrator according to the present invention.

### DESCRIPTION OF THE PREFERRED EMBODIMENTS

Reference now should be made to the drawings, in which the same reference numerals are used throughout the different drawings to designate the same or similar components. In the following description, when it is determined that the detailed description of the conventional function and conventional structure would confuse the gist of the present invention, such a description may be omitted. Furthermore, the terms and words used in the specification and claims are not necessarily limited to typical or dictionary meanings, but must be understood to indicate concepts selected by the inventor as the best method of illustrating the present invention, and must be interpreted as having had their meanings and concepts adapted to the scope and sprit of the present invention so that the technology of the present invention could be better understood.

Hereinafter, an embodiment of the present invention will be described in detail with reference to the attached drawings.

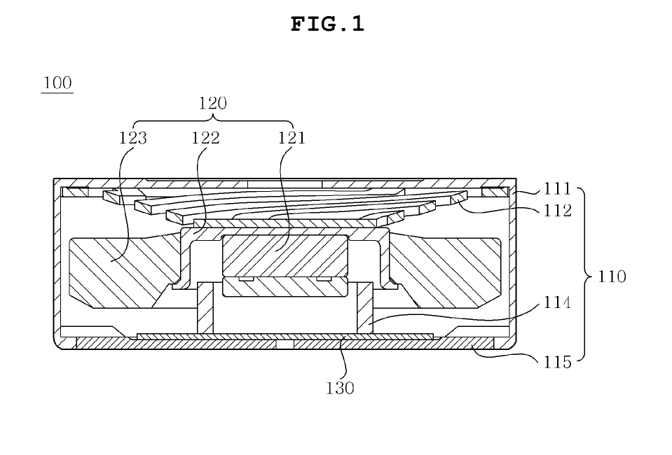

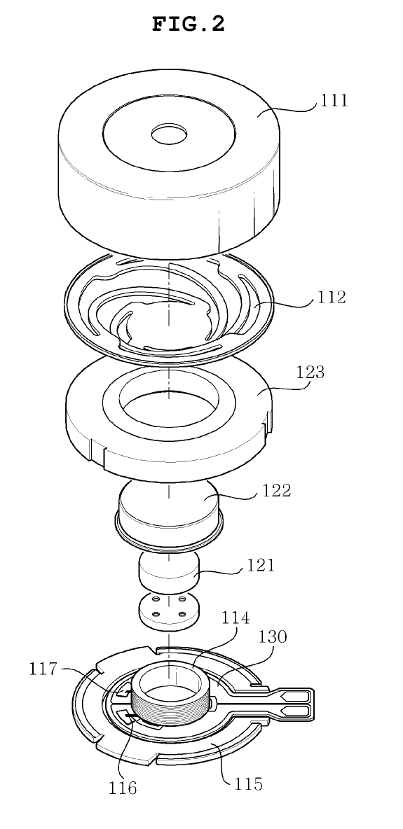

As shown in FIGS. 1 through 4, a linear vibrator 100 according to the present invention includes a stator 110 and a vibration unit 120. The vibration unit 120 vibrates in a vertical direction using reciprocal action between magnetic force generated by a magnet 121 and electromagnetic force which is generated by a coil unit 120 at a predetermined frequency.

The stator 110 includes a casing 111, a spring 112, the coil unit 114 and a bracket 115. The casing 111 defines an internal space of the linear vibrator 100 and covers elements of the linear vibrator 100. The spring 112 is disposed in the casing 111 and mounted to the upper plate of the casing 111 to elastically support the vibration unit 120. The coil unit 114 is coupled to the lower end of the vibration unit 120. The bracket 115 supports the entire linear vibrator 100.

The casing 111 covers the upper part and the side part of the linear vibrator 100 and thus protects the elements of the linear vibrator 100 from an external impact.

The spring 112 is an elastic member which is connected to the vibration unit 120 and induces vibrations of the vibration unit 120 in such a way that when a frequency is applied thereto, the maximum displacement occurs at a resonance point. The spring 112 is fastened at a circumferential upper end thereof to the inner surface of the upper plate of the casing 111 and fastened at a lower end thereof to the upper end of the vibration unit 120, thus elastically supporting the vibration unit 120.

Here, it is preferable that the spring 112 be a plate spring which can be varied in shape from a state in which the upper and lower ends of the spring are spaced apart from each other by a predetermined distance to a state in which they are in the same plane when the vibration unit 120 moves in the vertical direction. The spring 112 can be fastened to the upper plate of the casing 111 by bonding or using a separate fastening member which is forcibly fitted into the casing 111.

The coil unit 114 is mounted to the lower end of the vibration unit 120. The coil unit 114 generates a predetermined frequency and electromagnetic force in conjunction with the magnet 121.

Furthermore, a circuit board 130 which is provided with a variety of electric devices and an electric circuit is provided under the lower end of the coil unit 114 to apply an electric signal to the coil unit 114.

The circuit board 130 has a pattern which applies external power to the coil unit 114. Preferably, the circuit board 130 is made of elastic material.

The bracket 115 which supports the entire linear vibrator 100 thereon is coupled to the lower surface of the circuit board 130.

The bracket 115 is made of non-magnetic or low-magnetic material to prevent it from affecting a drive unit. The circuit board 130 which is connected to an input terminal is mounted on the bracket 115.

The vibration unit 120 which vibrates in the vertical direction includes a magnet 121, a yoke 122 which covers the magnet 121, and a weight 123 which is fitted over the to circumferential outer surface of the yoke 122 and has a predetermined weight.

The yoke 122 has a circular shape which covers the upper surface and the sidewall of the magnet 121. An annular rim is integrally provided on the lower edge of the yoke 122 to facilitate the seating of the weight 123 around the yoke 122. In addition, a coupling part (not shown) protrudes from the upper surface of the yoke 122 so that the spring 112 is coupled to the yoke 122 through the coupling part.

The yoke 122, along with the magnet 121, forms a magnetic circuit and optimizes the magnetic flux of the magnet 121 which is linked to the coil unit 114. Furthermore, the weight 123 is fitted over the yoke 122 and is seated onto the annular rim of the yoke 122. Hereby, the weight 123 can be reliably coupled to the yoke 122.

The weight 123 functions to increase vibrational force when the vibration unit 120 vibrates using reciprocal action generated between the magnet 121 and the coil unit 114 when a power signal is applied to the coil unit 114. The weight 123 is seated onto the annular rim of the yoke 122 in a shape in which it surrounds the yoke 122.

The weight 123 is preferably made of material having specific gravity higher than that of iron. The use of material having high specific gravity can increase the weight of the vibration unit 120 and leave the volume constant and thus control the resonance frequency for a certain weight of a vibrating body, thus maximizing the vibrational force of the vibrator.

The weight 123 is configured to be prevented from coming into contact with the coil unit 114, thus preventing abrasion therebetween. Preferably, the weight 123 extends in the radial direction in a shape corresponding to that of the spring 112 to increase the weight thereof. Due to this, the weight of the vibration unit 120 can be maximized in the given volume such that the vibrational force of the vibrator can be maximized.

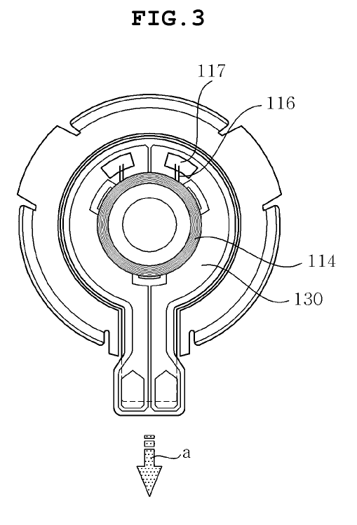

Meanwhile, as shown in FIG. 3, recently, according to the trend to reduce the size of the linear vibrator 100, the assembly structure of the linear vibrator 100 is also to complicated, and the structure for connecting power between the linear vibrator 100 and a portable electronic device is also complicated.

Therefore, there may be a problem in that a connector for applying power to the linear vibrator 100 may snap under the force applied to the linear vibrator 100 when it is connected to the electronic device. This problem renders the linear vibrator 100 inoperative, thus causing the entire electronic device to malfunction.

The present invention provides a structure preventing the above-mentioned problem. In the linear vibrator 100 according to the present invention, the coil unit 114 is perpendicularly attached to the circuit board 130. Furthermore, ends of lead wires 116 which extend from the lower end of the coil unit 114 are connected to the circuit board 130 by soldering. Hereby, soldering parts 117 are formed on the circuit board 130.

The circuit board 130 has predetermined elasticity, so that when power is applied to the circuit board 130, it is elastically extended in the direction (a) of FIG. 3 in which the tension is applied thereto.

Here, to prevent the lead wires 116 from being cut off from the soldering parts 117, the locations of the soldering parts 117 must be misaligned from the direction in which the tension is applied to the circuit board 130.

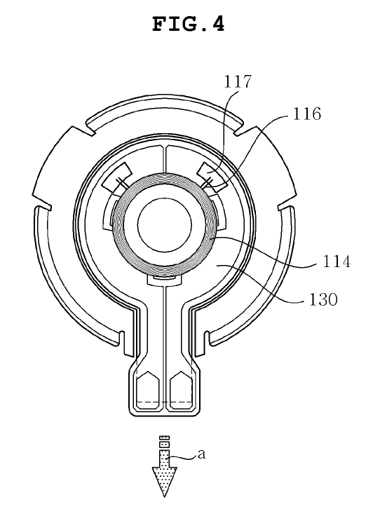

Preferably, as shown in FIG. 3, the orientation of the soldering parts 117 based on the center of the circuit board 130 is angled by 180° to the direction (a) in which the external tension is applied to the circuit board 130, thus preventing the external tension from affecting the soldering parts 117. Furthermore, as shown in FIG. 4, the soldering parts 117 can be oriented in any direction based on the center of the circuit board 130, so long as the soldering parts 117 are not aligned with the direction (a) of the external tension to prevent the soldering parts 117 from being directly affected by the external tension.

In other words, to minimize the force with which the external tension is applied to the soldering parts 117, it is preferable that the soldering parts 117 be disposed at positions spaced apart from the direction (a) of the external tension by from 90° to 180° based on the center of the circuit board 130.

As such, the orientation of the soldering parts 117 on which the lead wires 116 of the coil unit 114 are coupled to the circuit board 130 by soldering is not aligned with the direction (a) in which the external tension is applied to the circuit board 130. Therefore, when the circuit board 130 of the linear vibrator 100 is assembled with the electronic device, even though external tension is applied to the circuit board 130, the snapping of wires on the soldering parts 117 can be prevented.

Although the embodiments of the present invention have been disclosed for illustrative purposes, it will be appreciated that the linear vibrator of the invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A linear vibrator, comprising:
a casing defining an internal space therein;
a vibration unit provided in the casing, the vibration unit vibrating upwards and downwards;
a bracket supporting the casing and the vibration unit;
a circuit board provided on the bracket, the circuit board being made of elastic material, with an electric circuit and a plurality of electronic devices provided on the circuit board;
a coil unit mounted to a central portion of the circuit board in a perpendicular direction, so that power is applied from the circuit board to the coil unit;
a lead wire extending from a lower end of the coil unit, the lead wire being electrically connected to the circuit board; and
a soldering part formed on the circuit board to connect the lead wire to the circuit board, the soldering part being disposed at a position other than a position corresponding to a direction in which a tension is applied to the circuit board when power is applied to the coil unit.

2. The linear vibrator as set forth in claim 1, wherein an orientation of the soldering part based on a center of the circuit board is angled by 180° to the direction in which the external tension is applied to the circuit board.

3. The linear vibrator as set forth in claim 1, wherein an orientation of the soldering part based on a center of the circuit board is angled by from 90° to 180° to the direction in which the external tension is applied to the circuit board.
